(19) United States
(12) Patent Application Publication
(10) Pub. No.: US 2005/0286381 A1
(43) Pub. Date: Dec. 29, 2005

(54) Optical disk apparatus, system for evaluating optical disk apparatus, and program for evaluating the same

(75) Inventor: Hiroshi Okamoto, Ueda-shi (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/151,396

(22) Filed: Jun. 14, 2005

(30) Foreign Application Priority Data
Jun. 23, 2004 (JP) 2004-184708

(51) Int. Cl. G11B 5/09

(52) U.S. Cl. 369/59.1; 369/53.1; 369/47.1

(57) ABSTRACT

The optical disk apparatus is capable of easily evaluating quality of recorded data. The optical disk apparatus capable of writing data in an optical disk comprises: an optical pick-up irradiating an laser beam toward the optical disk and receiving a reflected laser beam reflected from the optical disk; an RF amplifier for creating a binarized RF signal, which alternately includes high level sections corresponding to lands formed in a recording surface of the optical disk and low level sections corresponding to pits formed in the recording surface of the optical disk, from the reflected laser beam received by the optical pick-up; and a circuit for measuring pulse widths of the high level section and the low level section of the binarized RF signal.

### BACKGROUND OF THE INVENTION

The present invention relates to an optical disk apparatus, a system for evaluating the apparatus and a program for evaluating the apparatus. More precisely, the system and the program evaluate quality of recorded data written by the apparatus.

Some users are interested in not only writing data in an optical disk, e.g., CD, DVD, but also quality of data recorded or written in the optical disk.

Conventionally, quality of data recorded in an optical disk of an optical disk apparatus is evaluated by, for example, checking error rata or checking asymmetry value β of a reflected laser beam received by an optical pick-up (see Japanese Patent Gazettes No. 2003-59047 and No. 200-162818).

Further, quality of recorded data can be evaluated by measuring pulse widths (time lengths) of high (H) level sections and low (L) level sections of a binarized RF signal (see FIG. 7).

The H-level sections and the L-level sections are alternately included in the binarized RF signal. The H-level sections indicate high light intensity of laser beams, which are reflected from lands formed in an recording surface of the optical disk and which are received by an optical pick-up; the L-level sections indicate low light intensity of laser beams, which are reflected from pits formed in the recording surface of the optical pick-up and which are received by the optical pick-up.

The pulse widths of the H-level sections and the L-level sections of the binarized RF signal depend on lengths of the lands and the pits formed in the recording surface of the optical disk (see FIG. 8).

In the optical disk, the lengths of the lands and pits are predetermined. The lands and pits are formed in a CD by irradiating FEM (Eight to Fourteen Modulation)-modulated laser beams from an optical pick-up or formed in a DVD by irradiating FEM⁺-modulated laser beams from the optical pick-up. By forming the lands and pits, data can be written or recorded in the optical disk.

By FEM-modulating or FEM⁺-modulating signals, the lengths of the lands and pits are determined on the basis of clock frequency.

In the following description, a standard length of the land and pit is defined as “T”. Actually, the lengths of the lands and pits formed in, for example, a DVD are 3T, 4T, . . . , 14T (except 12T and 13T). Namely, the length of the lands and pits are multiples of T.

Thus, quality of the recorded data can be evaluated by measuring pulse widths of the H-level sections and the L-level sections of the binarized RF signal and calculating deviations of the measured pulse widths from the predetermined lengths 3T . . . , 14T.

Note that, conventional optical disk apparatuses have no means for evaluating quality of data recorded in an optical disk. To evaluate quality of recorded data, a user must prepare a dedicated apparatus for evaluating quality of recorded data. However, the dedicated apparatuses are expensive, so they have been used by manufacturers of optical disk apparatuses. Namely, ordinary users cannot evaluate quality of recorded data.

A software for measuring pulse widths of a binarized RF signal, which can be installed in ordinary computers, exists, but it is usually used with the expensive dedicated apparatus. Therefore, ordinary users cannot use the software.

The dedicated apparatus measures the pulse widths by the steps of: inputting a non-binarized RF signal; binarizing the RF signal; measuring pulse widths of each level section of the binarized RF signal; and calculating deviations of the measured pulse widths.

When the dedicated apparatus is used, cable patterns on a printed circuit board of an optical disk apparatus must be cut, and lines extended from the dedicated apparatus must be connected to the cable patterns by, for example, soldering. However, this work is difficult for inexpert workers.

### SUMMARY OF THE INVENTION

An object of the present invention is to provide an optical disk apparatus, which is capable of easily evaluating quality of recorded data.

Another object of the present invention is to provide a system for evaluating an optical disk apparatus.

Further object is to provide a program for evaluating an optical disk apparatus.

To achieve the objects, the present invention has following structures.

Namely, the optical disk apparatus capable of writing data in an optical disk comprises:

an optical pick-up irradiating an laser beam toward the optical disk and receiving a reflected laser beam reflected from the optical disk;

means for creating a binarized RF signal, which alternately includes high level sections corresponding to lands formed in a recording surface of the optical disk and low level sections corresponding to pits formed in the recording surface of the optical disk, from the reflected laser beam received by the optical pick-up; and

means for measuring pulse widths of the high level section and the low level section of the binarized RF signal.

With this structure, an ordinary user can measure the pulse widths of the binarized RF signal, and quality of recorded data can be evaluated on the basis of the measured pulse widths.

In the optical disk apparatus, the measuring means may measure pulse widths of a plurality of the high level sections and a plurality of the low level sections of the binarized RF signal, and

the pulse widths of the high level sections and the low level sections may be collected in collecting means.

With this structure, the measured pulse widths are collected, and the quality of the recorded data can be easily evaluated by using the collected data.

In the optical disk apparatus, the collecting means may collect number of the high level sections having each of the pulse widths of the high level sections and number of the low level sections having each of the pulse widths of the low level sections as collected data.

Note that, the optical disk apparatus may further comprise an interface capable of forwarding the collected data to outside of the optical disk apparatus.

With this structure, the quality of the recorded data can be easily evaluated, on the basis of the collected data, by an external apparatus.

The system for evaluating the optical disk apparatus comprises a computer having:

display means;

an interface capable of communicating with the optical disk apparatus;

means for processing the collected data, which are sent from the optical disk apparatus via the interface, so as to analyze quality of recorded data; and

means for creating display data, which are shown on the display means, on the basis of the data processed by the processing means.

With this structure, the user can quantitatively see the processed data on the display means of the computer, so quality of recorded data can be easily and securely evaluated.

In the system, the processing means may process the collected data so as to show frequency distribution of the pulse widths of the high level sections, number of the high level sections having each of the pulse widths of the high level sections, the pulse widths of the low level sections and number of the low level sections having each of the pulse widths of the low level sections, and

the data creating means may create display data, which are data of the frequency distribution, on the basis of the data processed by the processing means.

Further, in the system, the display means may display the display data as a graph, in which a horizontal axis indicates the pulse width and a vertical axis indicates number of the high level sections and the low level sections.

With this structure, mountain-shaped curves, which correspond to lands and pits and have predefined widths, e.g., 3T, 4T, 5T, and whose peaks are located at prescribed positions, are shown on the display means. Therefore, the quality of the recorded data can be visually evaluated by seeing spreading of the mountain-shaped curves, so that the quality can be easily and joyfully evaluated.

Further, the program for evaluating the optical disk apparatus, which can be read by a computer having display means and an interface capable of communicating with the optical disk apparatus, has functions of:

processing the collected data, which are sent from the optical disk apparatus via the interface, so as to analyze quality of recorded data; and

creating display data, which are shown on the display means, on the basis of the processed data.

By using the program, the user can quantitatively see the collected data, which are measured pulse widths of the binarized RF signal, on the display means of the computer, so that the quality of the recorded data can be easily and securely evaluated. Note that, the computer may be an ordinary computer, so the quality of the recorded data can be evaluated without using an expensive computer.

In the program, the collected data may be processed so as to show frequency distribution of the pulse widths of the high level sections, number of the high level sections having each of the pulse widths of the high level sections, the pulse widths of the low level sections and number of the low level sections having each of the pulse widths of the low level sections, and

the display data may be data of the frequency distribution based on the processed data.

In the program, the display data may be data of a graph, in which a horizontal axis indicates the pulse width and a vertical axis indicates number of the high level sections and the low level sections.

By using the program, mountain-shaped curves, which correspond to lands and pits and have predefined widths, e.g., 3T, 4T, 5T, and whose peaks are located at prescribed positions, are shown on the display means. Therefore, the quality of the recorded data can be visually evaluated by seeing spreading of the mountain-shaped curves, so that the quality can be easily and joyfully evaluated.

### BRIEF DESCRIPTION OF THE DRAWINGS

Embodiments of the present invention will now be described by way of examples and with reference to the accompanying drawings, in which:

FIG. 1 is a block diagram of an optical disk apparatus;

FIG. 2 is an explanation view showing a method of collecting data of pulse widths;

FIG. 3 is a block diagram of a computer;

FIG. 4 is a block diagram of a system for evaluating the optical disk apparatus;

FIG. 5 is a flowchart showing action of the system;

FIG. 6 is graphs shown by a display;

FIG. 7 is an explanation view of a binarized RF signal; and

FIG. 8 is an explanation view of lands and pits formed on a recording face of an optical disk.

### DETAILED DESCRIPTION OF THE EMBODIMENTS

Preferred embodiments of the present invention will now be described in detail with reference to the accompanying drawings.

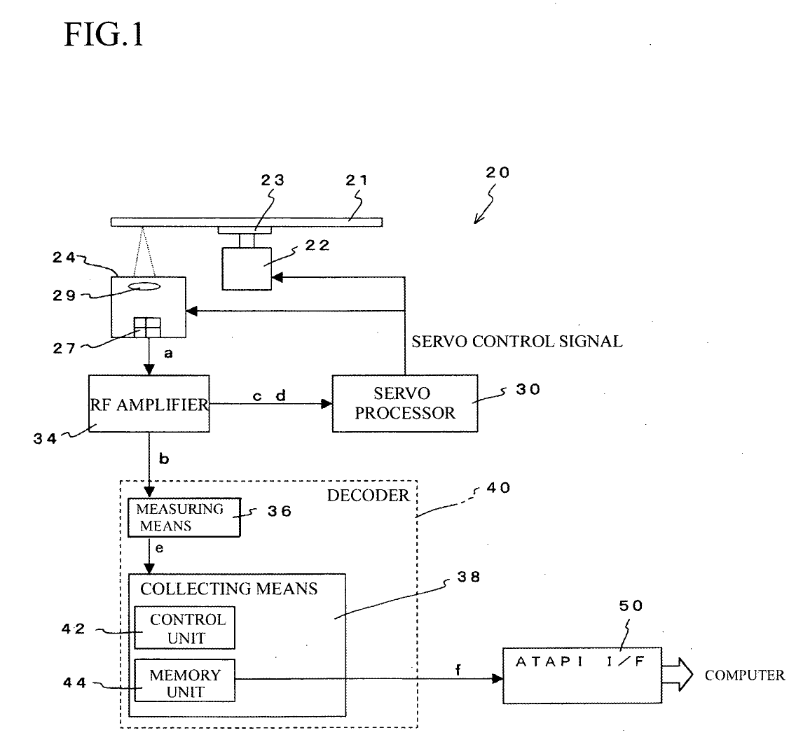

Firstly, a constitution of an optical disk apparatus of an embodiment will be explained with reference to FIG. 1.

An optical disk apparatus 20 comprises: a turn table 23, on which an optical disk 21 is set; a spindle motor 22 for rotating the turn table 23; and an optical pick-up 24 for irradiating a laser beam toward the optical disk 21 and receiving the laser beam reflected from the optical disk 21.

The optical pick-up 24 includes a laser diode (not shown) for irradiating the laser beam and a photo diode 27, which acts as a light receiving element. Further, an object lens 29, which focuses the laser beam to a recording layer of the optical disk 21, is provided in the optical pick-up 24.

The photo diode 27 converts intensity of the received reflected laser beam into voltage and sends a voltage signal a. The signal a is sent to an RF amplifier 34.

The RF amplifier 34, which acts as creating means, shapes waveforms of the signal a, which has been sent from the optical pick-up 24, and binarizes the signal a so as to create a binarized RF signal b.

As shown in FIG. 7, high (H) level sections and low (L) level sections are alternately appear in the binarized RF signal b. The intensity of the reflected laser beam corresponding to the H-level sections are high, namely the H-level sections correspond to lands in the recording face of the optical disk 21. On the other hand, the intensity of the reflected laser beam corresponding to the L-level sections are low, namely the L-level sections correspond to pits in the recording face of the optical disk 21.

Note that, a focus error signal generating circuit (not shown) and a tracking error signal generating circuit (not shown) are provided in the RF amplifier 34, and they respectively generate a focus error signal c and a tracking error signal d on the basis of the signal a sent from the optical pick-up 24.

The focus error signal c and the tracking error signal d are sent to a servo processor 30. The servo processor 30 controls focus servo and tracking servo on the basis of the signals c and d and servo-controls the spindle motor 22 and a movement of the optical pick-up 24.

Note that, an interface 50 for connecting to an external apparatus is provided to the optical disk apparatus. Several types of the interface 50, e.g., ATAPI (AT Attachment Packet Interface), USB (Universal Serial Bus), IEEE1394, can be employed.

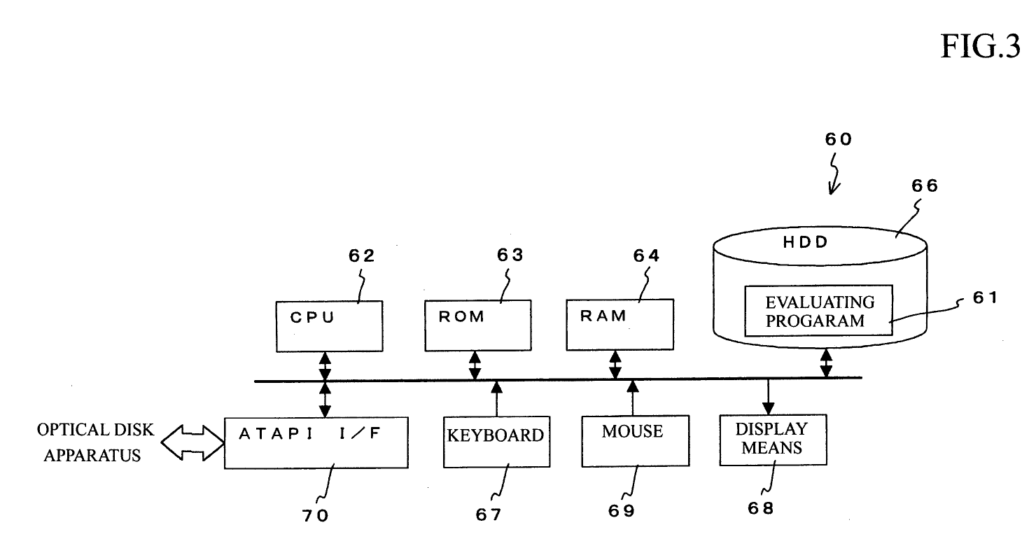

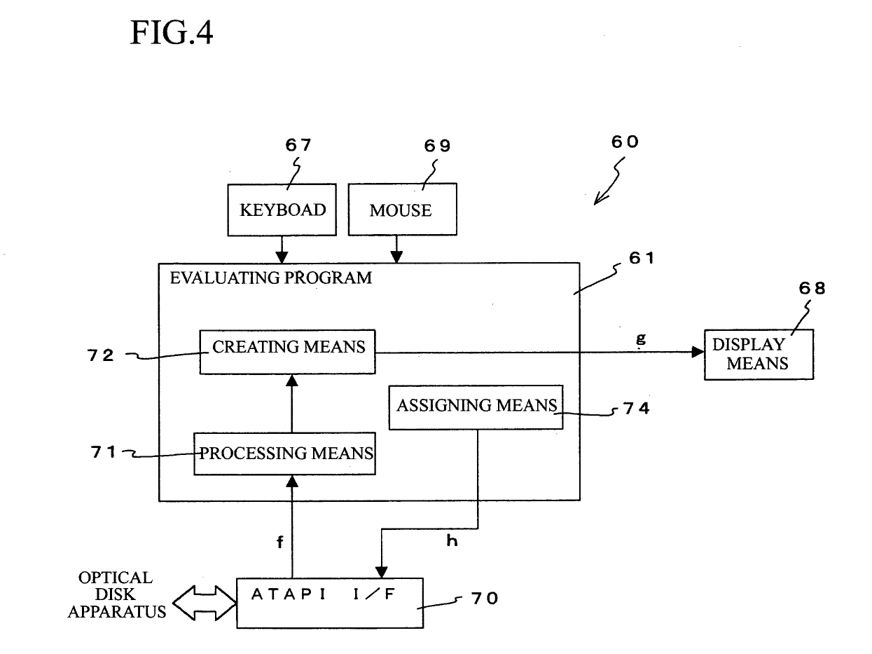

In the present embodiment, the optical disk apparatus employs the ATAPI type interface 50 so as to connect to a multipurpose computer 60 (see FIGS. 3 and 4).

Date f collected by collecting means 38 are converted into data, which can be treated by the computer 60, and outputted by the interface 50.

The binarized RF signal b, which has been generated by the RF amplifier 34, is sent to measuring means 36, which measures pulse widths. In the present embodiment, the measuring means 36 is one of functions of an IC, which acts as a decoder 40 for decoding the binarized RF signal b. However, the measuring means 36 is not limited to the present embodiment. For example, a circuit for or a software capable of measuring pulse widths may be employed as the measuring means 36.

Pulse widths e of the H-level sections and the L-level sections of the binarized RF signal b, which have been measured by the measuring means 36, are sent to the collecting means 38.

The collecting means 38 includes: a memory unit 44 for storing the pulse widths e and number of pulses for each pulse width e; and a control unit 42 for controlling the memory unit 44 to store the data measured by the measuring means 36 in the memory unit 44.

In the present embodiment, the collecting means 38 is one of functions of the IC, which acts as the decoder 40 for decoding the binarized RF signal b, as well as the measuring means 36. However, the collecting means 38 is not limited to the present embodiment. For example, a circuit separated from the IC may be employed as the collecting means 38.

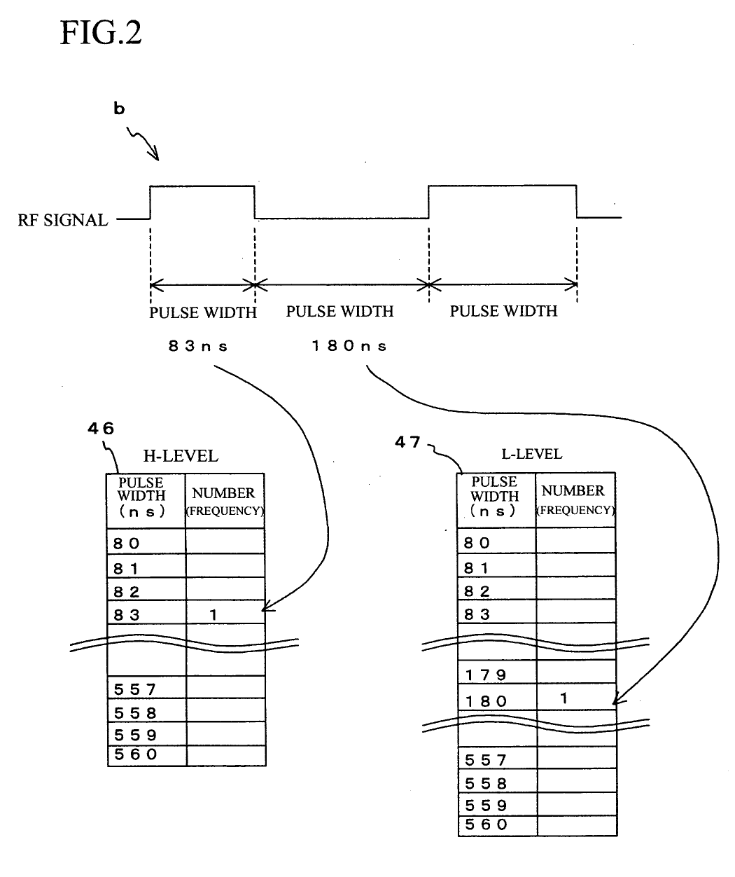

A data collecting method performed by the collecting means 38 will be explained with reference to FIG. 2.

The memory unit 44 of the collecting means 38 includes: a table 46 for storing pulse widths of the H-level sections and number of pulses for each pulse width thereof; and a table 47 for storing pulse widths of the L-level sections and number of pulses for each pulse width thereof. Namely, in the optical disk apparatus 20 of the present embodiment, the pulse widths of the H-level sections and the L-level sections, which are between a minimum value 3T, e.g., 80 ns, and a maximum value 14T, e.g., 560 ns, and number of pulses for each pulse width are respectively stored in the tables 46 and 47.

For example, when the measuring means 36 measures the H-level section of the binarized RF signal b having pulse width of 83 ns and the L-level section having pulse width of 180 ns, the control unit 42 controls the memory unit 44 to store number one for the pulse width 83 ns of the H-level pulse and number one for the pulse width 180 ns of the L-level pulse.

Then, the measuring means 36 continuously measures pulse widths of the H- and L-level sections of the binarized RF signal b, and the control unit 42 adds one to the number for each measured pulse width stored in the memory unit 44.

Next, the structure of the computer 60 will be explained with reference to FIGS. 3 and 4.

The computer 60 is an ordinary multipurpose computer. The computer 60 comprises: a central processing unit (CPU) 62; a ROM 63 and a RAM 64 for storing programs and data; a hard disk drive unit (HDD) 66 for storing programs and data; display means 68, e.g., CRT, LCD, for displaying data; and a keyboard 67 and a mouse 69 for inputting data.

The computer 60 has an interface 70 for connecting to the optical disk apparatus 20 so as to communicate therewith.

Several types of the interface 70, e.g., ATAPI (AT Attachment Packet Interface), USB (Universal Serial Bus), IEEE1394, can be employed.

In the present embodiment, the computer 60 employs the ATAPI type interface 70 so as to connect to the optical disk apparatus 20.

The computer 60 further comprises: processing means 71 for processing the collected data f so as to analyze quality of recorded data; and creating means 72 for creating display data g, which are shown on the display means 68, on the basis of the data processed by the processing means 71.

In the present embodiment, when the processing means 71 receives the collected data f from the optical disk apparatus 20 via the interface 70, the processing means 71 processes the data f so as to display them as frequency distribution.

The creating means 72 creates display data g, which are data for displaying the frequency distribution on the display means 68. The creating means 72 forwards the display data g to the display means 68, and the display means 68 displays graphs on the basis of the display data g.

The processing means 71 and the creating means 72 are realized by controlling the CPU 62 on the basis of the prescribed program 61. The program 61 is a program for evaluating the optical disk apparatus. The evaluating program 61 may be previously installed in the HDD 66.

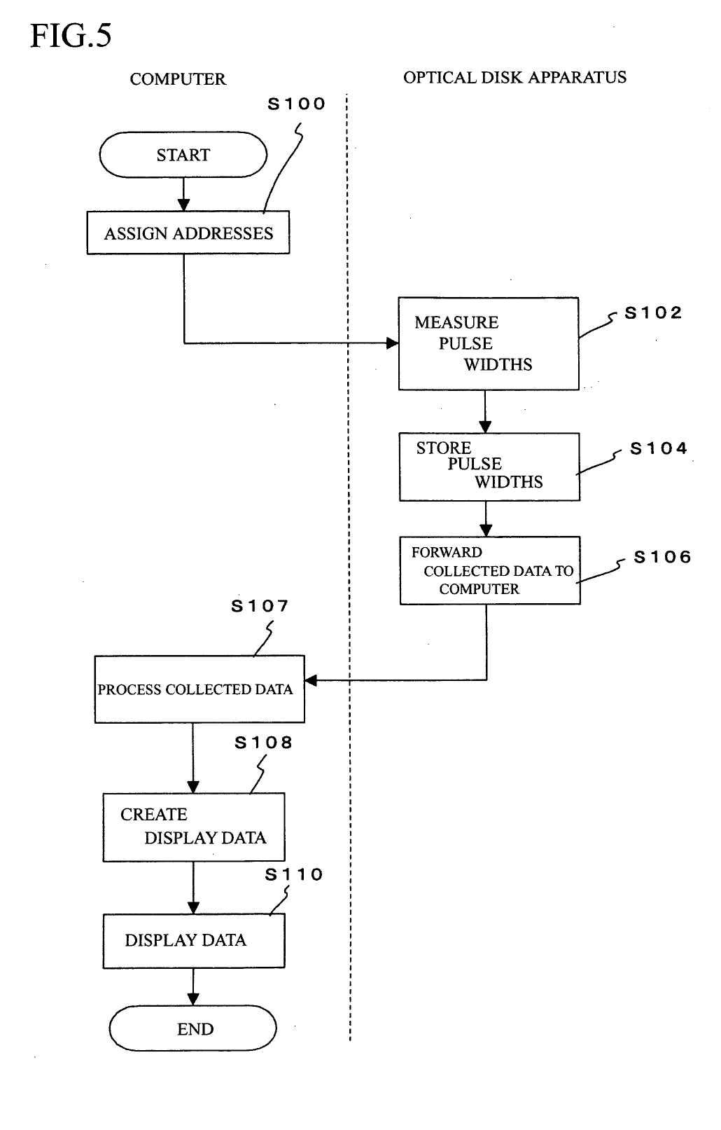

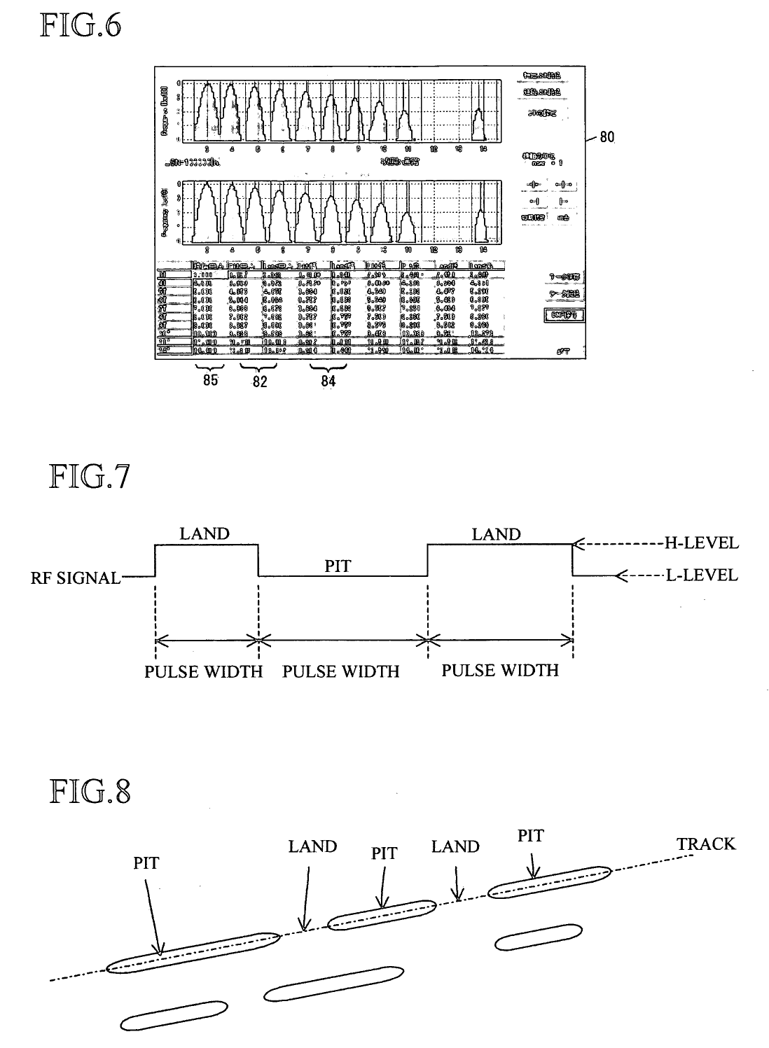

An example of the graph of frequency distribution is shown in FIG. 6. In FIG. 6, an upper graph is a graph of pits, which correspond to the L-level sections of the binarized RF signal; a lower graph is a graph of lands, which correspond to the H-level sections thereof. In the graphs, horizontal axes indicate pulse width (unit: T), and vertical axes indicate number of measured pulse width or frequency of the measured pulse width. Note that, the graphs in the vertical directions are log-compressed. The graphs are easily readable.

The evaluating program 61 is capable of assigning addresses of the optical disk 21 so as to measure the pulse widths of the H- and L-level sections of the binarized RF signal in the assigned addresses. At that time, the evaluating program 61 sends an address signal h to the optical disk apparatus 20.

Namely, when a user starts the evaluating program 61 with the keyboard 67 or the mouse 69, a message for assigning an address is displayed on the display means 68.

The user inputs an address of data to be evaluated to assigning means 74 of the computer 60 via the keyboard 67 or the mouse 69.

The assigning means 74 generates the address signal h on the basis of the address inputted by the user and sends the address signal h to the optical disk apparatus 20 via the interface 70.

The measuring means 36 of the optical disk apparatus 20 measures the pulse widths of the assigned address, which is assigned by the address signal h.

Successively, action of the system for evaluating the optical disk apparatus 20, which includes the computer 60, will be explained with reference to FIG. 5.

Firstly, the user starts the evaluating program 61 of the computer 60 (START).

When the evaluating program 61 is started, the user inputs addresses to be measured (step S100).

The address signal h of the assigned addresses is sent to the optical disk apparatus 20.

The measuring means 36 of the optical disk apparatus 20 measures the pulse widths of the H- and L-level sections of the binarized RF signal, which exists between the assigned addresses (step S102).

The collecting means 38 of the optical disk apparatus 20 collects number of the measured pulse widths for each pulse width of each level section (step S104). The concrete method of collecting the pulse width data has been described with reference to FIG. 2, so the method will be omitted here.

The control unit 42 of the collecting means 38 periodically forwards the collected pulse width data f to the computer 60 via the interface 50 (step S106).

In the computer 60, the processing means 71 processes the collected data f, which have been sent from the optical disk apparatus 20, so as to analyze quality of data recorded between the assigned addresses (step S107). For example, in the present embodiment, the collected data f are converted into data of frequency distribution.

Then, the creating means 72 processes the data of frequency distribution so as to create the display data g, which are data for displaying graphs on the display means 68 (step S108).

When the display data g are sent from the creating means 72 to the display means 68, the display means 68 displays the frequency distribution graphs of the measured pulse widths of the binarized RF signal on the basis of the display data g (step S110).

Upon displaying the graphs, the action of the system terminates (END).

An example of the frequency distribution graphs displayed by the display means 68 will be explained with respect to FIG. 6. As described above, in the graphs, the horizontal axes indicate pulse width (unit: T), and the vertical axes indicate number of measured pulse width or frequency of the measured pulse width. Note that, the unit of the horizontal axes can be selected, from T and nano second (nm), by a selection switch 80, which is also shown by the display means 68.

In each graph shown by the display means 68, 10 mountain-shaped waves are observed, and their peaks respectively correspond to pulse widths of 3T, 4T, 5T, 6T, 7T, 8T, 9T, 10T, 11T and 14T. Further, measured peak positions 82, measured widths 84, predetermined values 85 of the peaks, etc. are indicated in figures.

Note that, T is 38.2263 ns, so 3T is about 114 ns, 4T is about 153 ns, and 14T is about 535 ns. In FIG. 6, since the unit of the horizontal axes are T, the predetermined values 85 of the peaks are indicated as 3, 4, 5, . . . , 14.

By reading data recorded in the optical disk 21, which is attached in the optical disk apparatus 20, and displaying the collected data of the pulse widths of the binarized RF signal on the display means 68, the user is capable of evaluating quality of the recorded data.

In the present embodiment, since variation of the pulse widths of the binarized RF signal is shown as the graphs, the quality of the recorded data can be evaluated on the basis of overlapping the mountain-shaped waves, expansion thereof, etc. If the mountain-shaped waves are expanded and the adjacent waves are overlapped, variation of the pulse widths with respect to the predetermined values is great; quality of the recorded data is low. On the other hand, if the mountain-shaped waves are thin and the adjacent waves are separated, almost the pulse widths are near the predetermined values; quality of the recorded data is high.

Since the display means 68 displays the measured peak positions 82 and the predetermined values 85 of the peaks, the user can compare the both. If the measured peak positions 82 are deviated from the predetermined values 85, quality of the recorded data is low. On the other hand, if the measured peak positions 82 correspond to the predetermined values 85, quality of the recorded data is high.

The data of the frequency distribution graphs can be stored in the HDD 66 of the computer 60. When other data of frequency distribution graphs are created, the latter data can be compared with the former data by overlapping, so that qualities of the recorded data can be compared. Preferably, the creating means 72 transmits the frequency distribution graphs of the latter data through that of the former data, so that the both graphs can be overlapped and compared.

In the above described embodiment, the quality of the recorded data is evaluated on the basis of the expansion of the mountain-shaped waves (variation of the pulse widths or DD jitter) and deviations of the measured peaks with respect to the predetermined values. However, the evaluating method is not limited to the embodiment. For example, the quality may be evaluated by generating a standard clock signal from the binarized RF signal and measuring a deviation of the binarized RF signal with respect to the standard clock signal, i.e., pseudo DD jitter. Further, deviations of the pulse widths of the binarized RF signal with respect to ideal pulse widths thereof may be measured (a deviation method).

The processing means 71 is not limited to means for creating the data of frequency distribution. As described above, the processing means 71 may have the function of generating the standard clock signal from the binarized RF signal or measuring the deviations of the pulse widths of the binarized RF signal with respect to ideal pulse widths thereof.

The creating means 72 may creates data for displaying the deviation between the standard clock signal and the binarized RF signal or the deviations measured by the processing means 71. The display data are, of course, displayed by the display means 68.

Note that, the optical disk apparatus, the system and the program of the present invention are capable of evaluating quality of data written by not only the optical disk apparatus 20 but also other optical disk apparatuses.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. An optical disk apparatus capable of writing data in an optical disk, comprising:
an optical pick-up irradiating an laser beam toward the optical disk and receiving a reflected laser beam reflected from the optical disk;
means for creating a binarized RF signal, which alternately includes high level sections corresponding to lands formed in a recording surface of the optical disk and low level sections corresponding to pits formed in the recording surface of the optical disk, from the reflected laser beam received by said optical pick-up; and
means for measuring pulse widths of the high level section and the low level section of the binarized RF signal.

2. The optical disk apparatus according to claim 1,
wherein said measuring means measures pulse widths of a plurality of the high level sections and a plurality of the low level sections of the binarized RF signal, and
the pulse widths of the high level sections and the low level sections are collected in collecting means.

3. The optical disk apparatus according to claim 2,
wherein said collecting means collects number of the high level sections having each of the pulse widths of the high level sections and number of the low level sections having each of the pulse widths of the low level sections as collected data.

4. The optical disk apparatus according to claim 3,
further comprising an interface capable of forwarding the collected data to outside of said optical disk apparatus.

5. A system for evaluating the optical disk apparatus of claim 4, comprising a computer having:
display means;
an interface capable of communicating with the optical disk apparatus;
means for processing the collected data, which are sent from the optical disk apparatus via the interface, so as to analyze quality of recorded data; and
means for creating display data, which are shown on said display means, on the basis of the data processed by said processing means.

6. The system according to claim 5,
wherein said processing means processes the collected data so as to show frequency distribution of the pulse widths of the high level sections, number of the high level sections having each of the pulse widths of the high level sections, the pulse widths of the low level sections and number of the low level sections having each of the pulse widths of the low level sections, and
said data creating means creates display data, which are data of the frequency distribution, on the basis of the data processed by said processing means.

7. The system according to claim 6,
wherein said display means displays the display data as a graph, in which a horizontal axis indicates the pulse width and a vertical axis indicates number of the high level sections and the low level sections.

8. A program for evaluating the optical disk apparatus of claim 4, which can be read by a computer having display means and an interface capable of communicating with the optical disk apparatus,
having functions of:
processing the collected data, which are sent from the optical disk apparatus via the interface, so as to analyze quality of recorded data; and
creating display data, which are shown on said display means, on the basis of the processed data.

9. The program according to claim 8,
wherein the collected data are processed so as to show frequency distribution of the pulse widths of the high level sections, number of the high level sections having each of the pulse widths of the high level sections, the pulse widths of the low level sections and number of the low level sections having each of the pulse widths of the low level sections, and
the display data are data of the frequency distribution based on the processed data.

10. The program according to claim 8,
wherein the display data are data of a graph, in which a horizontal axis indicates the pulse width and a vertical axis indicates number of the high level sections and the low level sections.
